(19) United States
(12) Patent Application Publication
(10) Pub. No.: US 2019/0077181 A1
(43) Pub. Date: Mar. 14, 2019

(54) APPARATUS FOR TURNING PAGES OF A BOOK AND METHOD FOR SAME

(71) Applicant: CASIO COMPUTER CO., LTD., Tokyo (JP)

(72) Inventors: Hirokazu HASEGAWA, Tokyo (JP); Toshiaki KANAMURA, Tokyo (JP); Yasushi MURAI, Tokyo (JP)

(73) Assignee: CASIO COMPUTER CO., LTD., San Jose, CA (US)

(21) Appl. No.: 16/100,822

(22) Filed: Aug. 10, 2018

(30) Foreign Application Priority Data
Sep. 14, 2017 (JP) 2017-177078

(51) Int. Cl. B42D 9/04

(52) U.S. Cl. CPC B42D 9/04; H04N 5/2253

(57) ABSTRACT

A page-turner restricts the movement of a page to be turned by pressing a predetermined upper surface on the binding side of the page by an arm until, an end of the page starts to be caught at a page-turning end point by a catching section, in synchronization with a page-turning operation. The page turner rotates the arm so the arm enters a released state which is a substantially vertical state at timing at which the page separates from a sticking section and starts to be caught by the catching section. The page to be turned is pulled in by a page holding section while being inclined without the end of the page curling in a U shape.

### CROSS-REFERENCE TO RELATED APPLICATION

This application is based upon and claims the benefit of priority from the prior Japanese Patent Application No. 2017-177078 filed Sep. 14, 2017, the entire contents of which are incorporated herein by reference.

### BACKGROUND OF THE INVENTION

### 1. Field of the Invention

The present invention relates to a technique for turning pages of a book.

### 2. Description of the Related Art

Conventionally, an apparatus is known which turns overlapping pages of a book or the like one by one by sticking thereto (refer, for example, to Japanese Patent Application Laid-Open (Kokai) Publication No. 2016-010907). This apparatus sequentially turns pages of a hook by repeating operations for (i) holding and turning pages of the book by a sticking member or the like and (ii) catching and pressing the turned pages by a page holding section constituted by a roller or the like on the page-turning end side so that the turned pages do not to return to their page-turning start points. In the processes of the operation for sequentially turning pages, the pages are sequentially imaged by a camera connected to a personal computer, or a mobile phone, a smartphone, a tablet or the like having a camera (not shown).

In the above-described apparatus, an end E of a turned page P may enter a roller 70 in the page holding section with it being in a U shape due to a relation between the size of the book, the paper quality of the pages, and the like and the attachment position of the page holding section at the page-turning end point, as shown in FIG. 7. Thus, when the position of the paper of a turned page P is inappropriate, a paper jam occurs in the roller 70 which presses pages in the vicinity of page-turning end points.

### SUMMARY OF THE INVENTION

In accordance with one aspect of the present invention, there is provided an apparatus for turning pages of an opened book, comprising: a turning mechanism which holds a page at a page-turning start point and turns over the page; a page holding section which moves the page turned over by the turning mechanism to a page-turning end point while catching the page by rotating, and holds the page; and a restriction section which restricts, during a page-turning operation by the turning mechanism, a page movement caused by the page-turning operation.

In accordance with another aspect of the present invention, there is provided a method for turning pages of an opened book, comprising holding a page at a page-turning start point by a turning mechanism and turning over the page toward a page-turning end point; restricting, during a page-turning operation by the turning mechanism, a page movement caused by the page-turning operation; and moving the page at a position in middle of the page-turning operation by the turning mechanism to the page-turning end point while catching the page by a page holding section.

In accordance with another aspect of the present invention, there is provided a method for turning pages of an opened book, comprising: holding an end of a page at a page-turning start point by a turning mechanism with a predetermined upper surface on a binding side of the page at the page-turning start point being pressed by a control mechanism, and turning over the page toward a page-turning end point; and releasing press of the control mechanism against the predetermined upper surface at timing at which the page turned over by the turning mechanism starts to be caught by a holding mechanism provided at the page-turning end point.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more clearly understood by the detailed description below when considered together with the following drawings.

FIG. 1 is a perspective view showing a schematic structure of a page turner 1 according the present embodiment;

FIGS. 2A and 2B are each a side view schematically showing an operation of a position control section according to the present embodiment;

FIG. 3 is a perspective view for describing a page-turning operation by the page turner 1 according the present embodiment;

FIG. 4 is a block diagram showing the structure of a control and driving system of the page turner 1 according the present embodiment;

FIG. 5 is a flowchart for describing operations in page-turning processing that is performed by the page turner 1 according to the present embodiment;

FIGS. 6A and 6B are each a flowchart for describing respective operations of a motor driver 205 and a position control section 50 according to the present embodiment; and

FIG. 7 is a conceptual diagram for describing a page jam occurring in a conventional page turner.

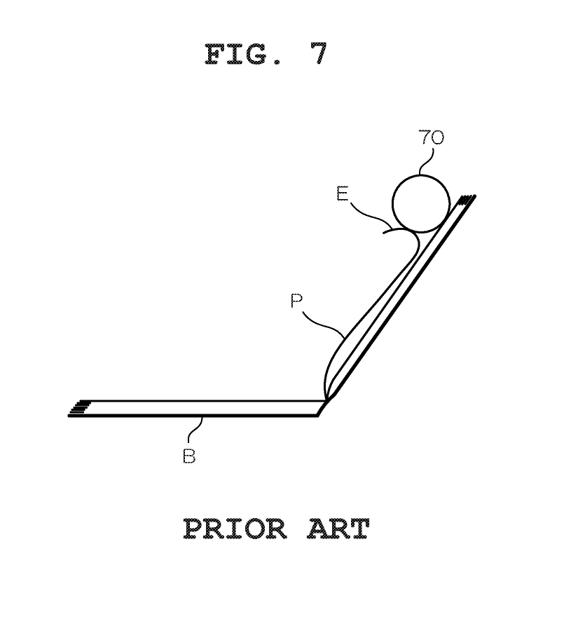

### DETAILED DESCRIPTION OF THE PREFERRED EMBODIMENT

A preferred embodiment of the present invention will hereinafter be described with reference to the accompanying drawings. Note that, although the embodiment described below is provided with various technically preferable limitations in order to carry out the present invention, these limitations are not intended to limit the scope of the present invention to the embodiment and examples shown in the drawings.

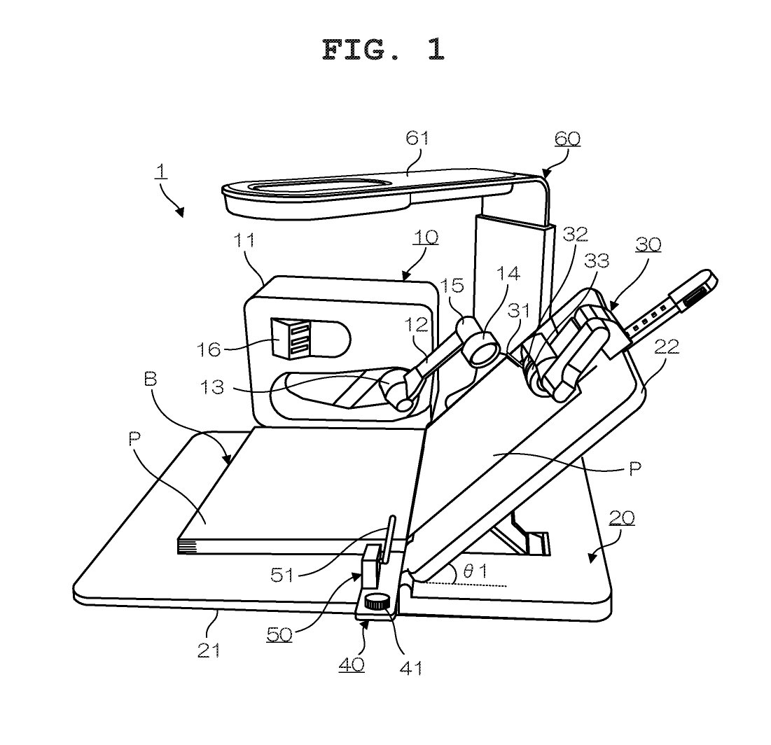

FIG. 1 is a perspective view showing the appearance of a page turner 1 according to an embodiment of the present invention. Note that in the following descriptions, a case is described in which pages P of a book B are turned from left to right. In FIG. 1, the page turner 1 includes a page-turning main body section 10 which turns pages P of the book B, a holding table 20 which holds the opened book B, a page holding section (holding mechanism) 30 which holds pages P at a page-turning end point, a book holder 40 which fixes the book B held by the holding table 20, a position control section (control mechanism) 50 for controlling the positions of pages P, and an imaging apparatus stand 60 on which an information processing terminal (a smartphone a tablet, etc.) including a camera for photographing pages P of the book B is installed.

The page-turning main body section 10 includes an accommodation case 11 having a substantially rectangular parallelepiped shape, an arm section 12 which can be accommodated in the accommodation case 11, a first driving section 13 such as a motor which reciprocates the arm section 12 from right to left and from left to right, a sticking section (sticking roller section) 14 which is attached to a distal end of the arm section 12 and sticks to a page p of the book B, a second driving section 15 such as a motor which rotates the sticking section 14 an air blowing section 16 which makes air pass above pages P at a page-turning start point and blows air against a page P being turned by the sticking section 14 so as to assist the page-turning operation, or separates the page P from the sticking section 14, and a control section not shown which controls respective operations of these sections. A position and a direction of the page-turning main body section 10 with respect to the holding table 20 can be adjusted as needed, based on the size of the book B.

The holding table 20 includes a pair of holding plates 21 and 22 which is foldable by a hinge. Here, in the case where pages P of the book B are turned from left to right, the one holding plate 21 located on the left side in the pair of holding plates 21 and 22 is placed along the top of the table, and the other holding plate 22 located on the right side is placed on the table while being inclined to rise at a predetermined angle to the one holding plate 21. On the one holding plate 21, the book B whose pages P have not been turned is placed. That is, a position on the side of the one holding plate 21 becomes a page-turning start point of each page P. On the other holding plate 22, turned pages P are held. That is, a position on the side of the other holding plate 22 becomes a page-turning end point of each page P.

As a result, the holding table 20 holds the book B such that pages P at page-turning end points are more inclined in a direction to rise with respect to the seam of the book B than pages P at page-turning start points. Note that, since the pair of holding plates 21 and 22 is foldable by the hinge, an angle formed between the pair of holding plates 21 and 22 can be adjusted and a tilt angle θ1 of a page P at a page-turning end point with respect to the horizontal plane is adjustable. The tilt angle θ1 is preferably adjusted in a range of 30° to 45°.

The page holding section 30 includes a catching section 31 which catches a page P turned by the reciprocable swing of the sticking section 14 and thereby prevents the page P from returning to the page-turning start point, a pull-in roller 32 which rotates coaxially with the catching section 31 and pulls in a page P conveyed by the sticking section 14 and caught by the catching section 31 so as to prevent the page P from returning to the page-turning start point, and a pressing roller 33 which presses a page P at a page-turning end point.

The book holder 40, which is constituted by an elongate plate-like member, is inserted between the front cover (or back cover) of the book B placed on the holding plate 21 and the final cage P, and is fixed to the holding plate 21 by tightening a fixing knob 41 to prevent the book B from shifting during the page-turning operation.

The position control section 50 is detachably fixed on the book holder 40, The position control section 50 includes a driving section (not shown) such as a motor and an arm 51 connected to the rotation axis of the driving section. The position control section 50 is when the arm 51 is in a state of pressing the upper surface of a page P (a substantially horizontal state), fixed on the book holder 40 such that a distal end portion of the arm 51 is at a position where the upper surface of the page P which has not been turned is pressed downward. In other words, the fixing position of the position control section 50 on the book holder 40 is adjustable in the longitudinal direction of the book holder 40, based on the size of the book B.

Also, since the position control section 50 is fixed on the book holder 40, the position of the distal end portion of the arm 51 on the page P depends on the fixing position on the book holder 40. In other words, by the fixing position on the book holder 40 being adjusted based on the size of the book B, the stiffness of the page P, or the like, the position of the distal end portion of the arm 51 on the page P can be adjusted. Note that details of operations of the arm 51 by the position control section 50 are described later.

The imaging apparatus stand 60 includes a stage 61 that is extending diagonally to a page P at a page-turning start point of the opened book B serving as an imaging target (a page P which has not been turned) and parallel to the installation surface of the imaging apparatus stand 60. On the stage 61, a tablet terminal (not shown) is installed as an information processing terminal, and a camera section in the tablet terminal photographs a page P at a page-turning start point (a page which has not been turned) of the book B via an opening provided in the stage 61. The position and the direction of the imaging apparatus stand 60 can be adjusted as needed based on the size of the book B.

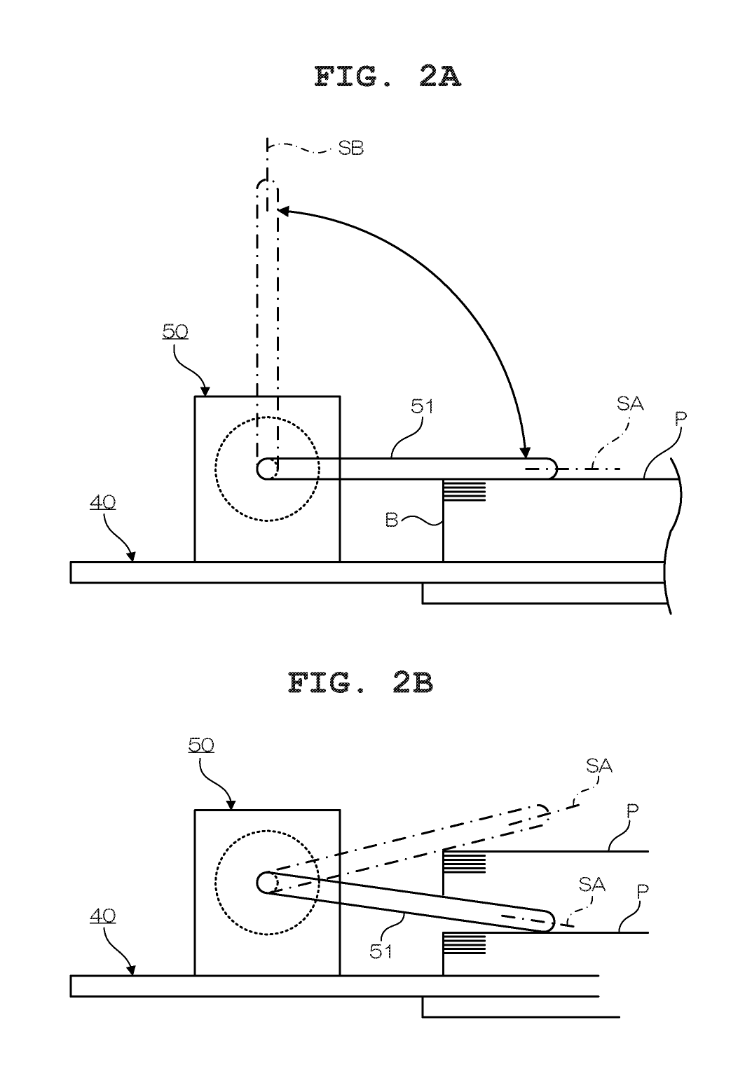

FIG. 2A and FIG. 2B are each a conceptual diagram for describing an operation of the position control section 50 according to the present embodiment. The position control section 50 operates the arm 51 to reciprocally swing between a page pressed (substantially horizontal) state SA where the movement of a page P to be turned is restricted and a standing and releasing (substantially vertical) state SB where the movement of a turned page P is not restricted according to control by the control section in the page-turning body section 10, as shown in FIG. 2A.

Note that, as shown in FIG. 2B, there is a case where the height of remaining pages P which have not been turned is larger than that of the rotation axis of the arm 51, and a case where the height of remaining pages P which have not been turned is smaller than that of the rotation axis of the arm 51 by the number of the remaining pages decreasing along with the repetition of a page-turning operation, depending on the number of the pages of the book B. In either case, a DC (direct current) motor (containing a reduction gear) is used for a driving section in the position control section 50. Thus, a certain degree of pressing force by the arm 51 is applied to pages P, whereby the movement (upward lifting movement) of a page P to be turned can be sufficiently restricted.

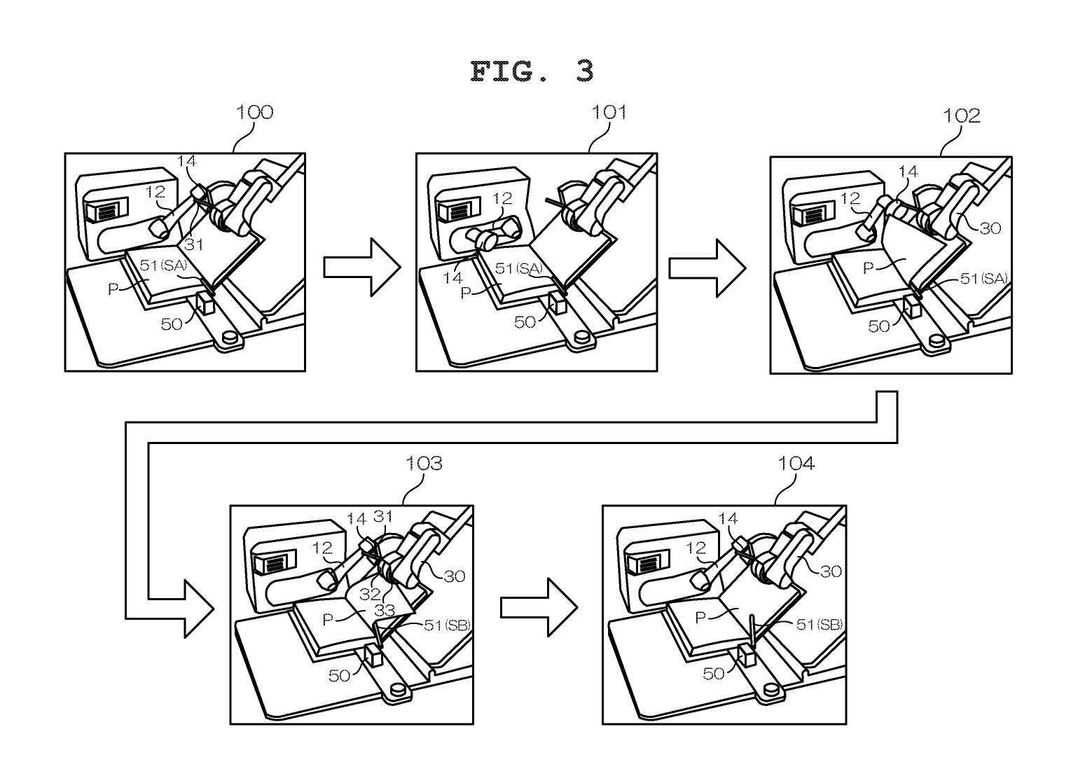

FIG. 3 is a conceptual diagram for describing a page-turning operation by the page turner 1 according to the present embodiment and an operation of the position control section 50.

In the above-described structure, when the first driving section 13 is rotated, the arm section 12 reciprocates between a page-turning start point of pages P and a page-turning end point thereof as if it draws an arc centered on the first driving section 13. In the following descriptions, a movement from a page-turning start point of pages P to a page-turning end point thereof is regarded as a forward movement, and a movement from a page-turning end point to a page-turning start point is regarded as a backward movement.

First, before a page-turning operation is started, the arm section 12, i.e., the sticking section 14 is on the side of a page-turning end point, as indicated by a block 100. Here, the position control section 50 is in the page pressed state SA where the movement of a page P to be turned is being restricted by the rotated arm 51.

Then, when a page-turning operation is started, the arm section 12, i.e., the sticking section 14 moves to a page-turning start point and sticks to the first page P, indicated by a block 101. Here, the position control section 50 maintains the page pressed state SA of the arm 51.

Then, when the arm section 12, i.e., the sticking section 14 rotates to a page-turning end point, an end (on the outside margin side) of the page P stuck to the sticking section 14 moves to the page-turning end point, as indicated by a block 102. Here, the movement of the binding portion of the page P stuck to the sticking section 14 has been restricted by the arm 51 of the position control section 50. Thus, the end of the page P is not pulled in by the pull-in roller 32 and the pressing roller 33 in the page holding section 30.

Furthermore, when the arm section 12, i.e., the sticking section 14 rotates, the end of the page P stuck to the sticking section 14 separates from the sticking section 14, and is caught by the page holding section 30, as indicated by a block 103. At this timing at which the end of the page p separates from the sticking section 14, the position control section 50 rotates the arm 51 to enter the standing and releasing (substantially vertical) state SB where the movement of the page P is not restricted. In parallel with a process for the arm 51 to rotate to enter the standing and releasing (substantially vertical) state SB, the end of the page P separated from the sticking section 14 is pulled in by the catching section 31, the pull-in roller 32, and the pressing roller 33 in the page holding section 30.

Finally, the turned page P is completely pulled in by the page holding section 30 and held therein, as indicated by a block 104. The arm 51 of the position control section 50 enters the standing and releasing (substantially vertical) state SB where the movement of the page P is not restricted. Then, the position control section 50 rotates the arm 51 to enter the page pressed state SA where the movement of the subsequent page P is restricted, as indicated by the block 100.

As such, according to the present embodiment, when the arm 51 of the position control section 50 restricts the movement of the binding portion of a page P to be turned (e.g., the binding portion of a page P located diagonally to a corner portion of the page P stuck to by the sticking section 14) in synchronization with a page-turning operation, the distance between the end of the page P and the page holding section 30 is adjusted, the corner portion of the page P is first caught by the catching section 31 in the page holding section 30 (see the block 103 shown in FIG. 3), and the end of the page P is then pulled in by the catching section 31, the pull-in roller 32, and the pressing roller 33 in the page holding section 30 while being inclined. Therefore, the end of the page P can be prevented from curling in a U shape, and a paper jam can be prevented from occurring by the pull-in roller 32 and the pressing roller 33 in the page holding section 30.

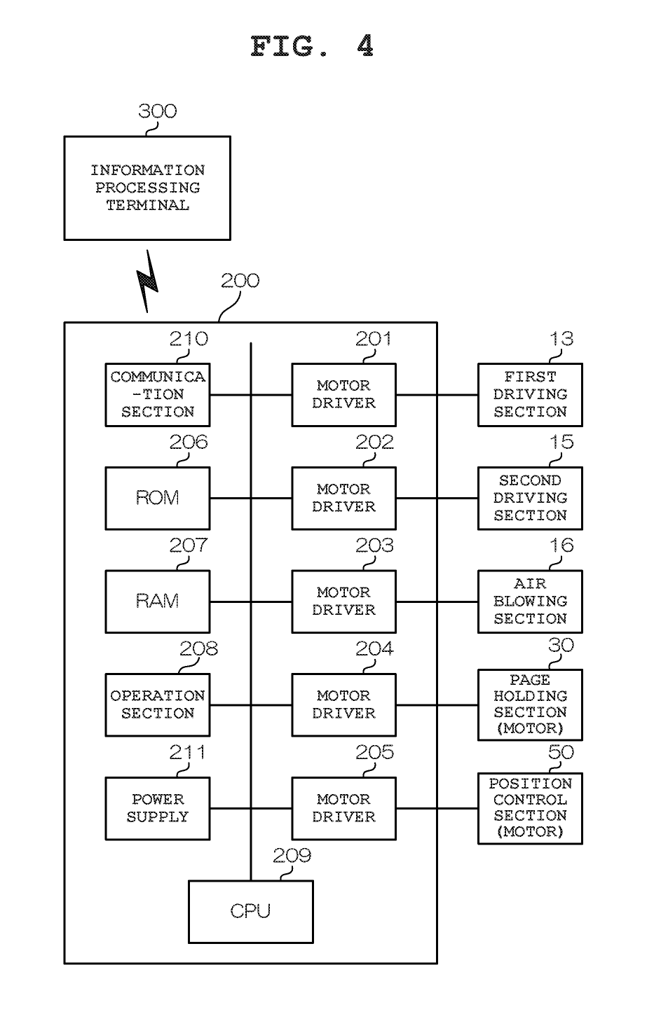

FIG. 4 is a block diagram showing the structure of a control system in the page turner 1 according the present embodiment. As shown in FIG. 4, a control section 200 in the page turner 1 includes a motor driver 201 for driving the first driving section 13, a motor driver 202 for driving the second driving section 15, a motor driver 203 for driving the air blowing section 16, a motor driver 204 for driving the page holding section (motor) 30, a motor driver 205 for driving the position control section (motor) 50, a ROM (Read-Only Memory) 206 in which various programs are recorded, a RAM (Random Access Memory) 207 into which a program recorded in the ROM 206 is loaded, an operation unit 208 to which various types of instructions are inputted, a CPU (Central Processing Unit) 209 which controls the motor drivers 201 and 205 by loading a program recorded in the ROM 206 into the RAM 207 and executing the program based on instructions from the operation section 208, a communication section 210 connected to the information processing terminal 300, and a power supply 211. The operation section 208 is provided with, for example, a power switch for turning on/off the power to the page turner 1. Note that the operation of the page turner 1 (settings for various types of parameters for a page-turning operation, an instruction to start/stop the page-turning operation, etc.) is indicated/set by the information processing terminal 300. In addition, the CPU 209 may be a processor in a broader sense.

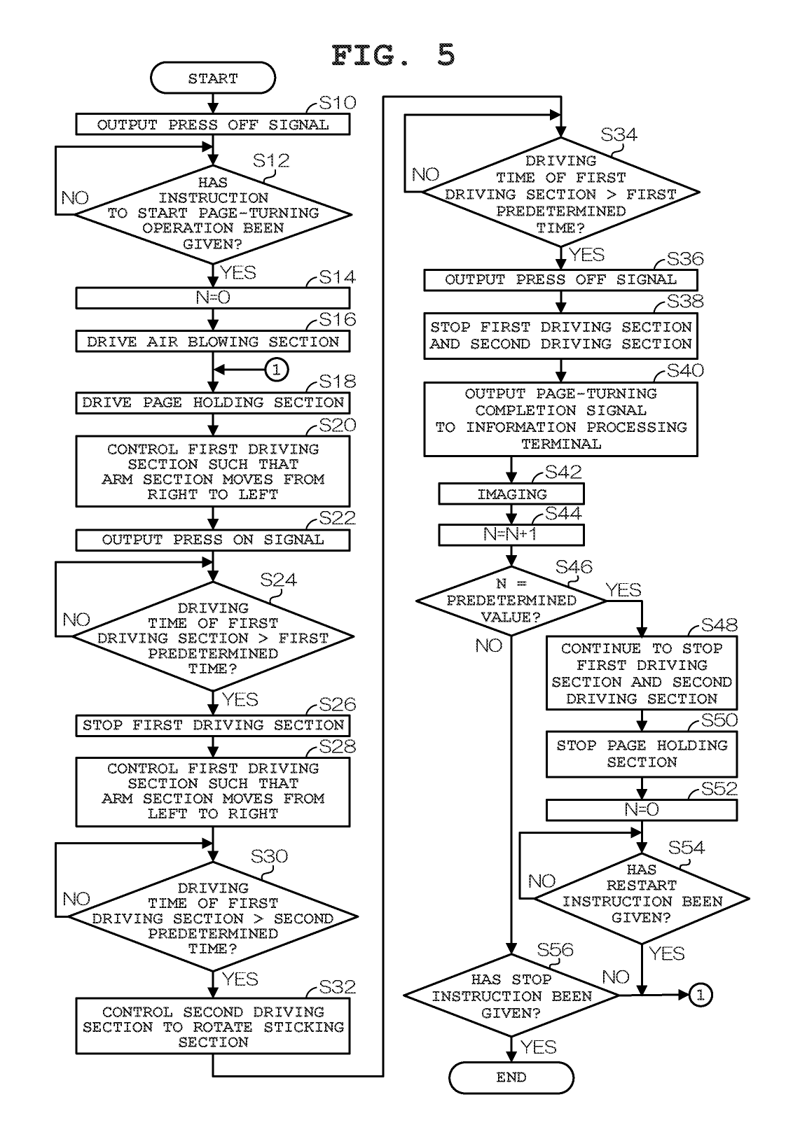

FIG. 5 is a flowchart for describing operations of the page turner 1 according to the present embodiment.

First, preparation before execution of page-turning processing is described.

The user rotates the arm section 12 and the sticking section 14 to pull them out of the accommodation case 11 in the page turner 1 in an accommodated state, and switches the page turner 1 to an operation state in which the arm section 12 operates (see FIG. 1). Then, the user installs the holding table 20, places the book B on the holding plate 21, inserts the book holder 40 between the front cover (or the back cover) of the book B placed on the holding plate 21 and the final page P, and fixes the book holder 40 to the holding plate 21 by tightening the fixing knob 41 in the book holder 40.

After placing the book B, the user sets the page holding section 30 on the holding plate 22 while adjusting its position, and manually inserts and fixes the front cover of the book B into and to the page holding section 30. Note that the user may fix the front cover of the hook B to the holding plate 22 with a clip not shown. Next, the user adjusts the moving direction of air from the air blowing section 16 such that the air passes above pages P at page-turning start points and is blown onto a page p at a page-turning end point.

Also, the user aligns the arm section 12 such that the sticking section 14 is arranged at a start point (an end point of a backward movement) in advance. More specifically, the user adjusts the position of the holding table 20 such that the sticking section 14 comes in contact with the vicinity of the upper left of a page P at a page-turning start point. Then, the user opens the book B to the preceding page P of a page P which the user desires to start to scan, and moves the sticking section 14 to an end point of a forward movement (a start point position of the backward movement) in advance (see the block 100 shown in FIG. 3). Also, the user adjusts the position of the information processing terminal 300 on the stage 61 in the imaging apparatus stand 60 such that the page P at the page-turning start point comes within the viewing angle of the camera in the information processing terminal 300.

When the user turns on the power supply 211 in the page turner 1 upon completion of the preparation, the CPU 209 loads a program for page-turning processing recorded in the ROM 206 into the RAM 207 and executes the program.

First, as shown in FIG. 5, the CPU 209 outputs a press OFF signal to the motor driver 205 for driving the position control section (motor) 50 (Step S10). Thus, the arm 51 of the position control section 50 enters the standing and releasing (substantially vertical) state SB where the movement of a page P is not restricted. Then, the CPU 209 judges whether or not the user has given an instruction to start a page-turning operation (Step S12). When judged that no instruction has been given to start a page-turning operation (NO at Step S12), the CPU 209 continues the current state.

On the other hand, when judged that an instruction to start a page-turning operation has been given (YES at Step S12) the CPU 209 resets an N value stored in the RAM 207 to zero (Step S14). Details of the N value is described later. Then, the CPU 209 causes the motor driver 203 to drive the air blowing section 16 to blow air from the air blowing section 16 (Step S16), and causes the motor driver 204 to drive the page holding section 30 to rotate the catching section 31, the pull-in roller 32, the pressing roller 33, and the like (Step S18).

Then, the CPU 209 causes the motor driver 201 to control the operation of the first driving section 13 such that the arm section 12 moves from right to left (moves backward) (Step S20). Here, the CPU 209 outputs a press ON signal to the motor driver 205 for driving the position control section (motor) 50 (Step S22). As a result, the arm 51 of the position control section 50 enters the page pressed state SA where the movement of a page P is restricted.

Then, the CPU 209 judges whether or not the driving time of the first driving section 13 has exceeded a first predetermined time period (Step S24). The first predetermined time period has been set to a time period during which the arm section 12 can be moved from a start point to an end point of the backward movement. When judged that the driving time is equal to or less than the first predetermined time period (NO at Step S24), the CPU 209 continues to drive the first driving section 13.

Conversely, when judged that the driving time has exceeded the first predetermined time period (YES at Step S24), the CPU 209 causes the motor driver 201 to stop the operation of the first driving section 13 (Step S26). As a result, the sticking section 14 sticks to a page P on the left side with its rotation being stopped (see the block 101 shown in FIG. 3).

Then, the CPU 209 causes the motor driver 201 to control the operation of the first driving section 13 such that the arm section 12 moves from left to right (moves forward) (Step S28). As a result, the page P at its page-turning start point starts to move to a page-turning end point with it being stuck to the sticking section 14 (see the block 102 shown in FIG. 3).

Then, the CPU 209 judges whether or not the driving time of the first driving section 13 has exceeded a second predetermined time period (Step S30). The second predetermined time period has been set to a time period shorter than the first predetermined time period. In particular, the second predetermined time period should preferably be set to be equal to a time period from when the arm section 12 starts moving forward until when the arm section 12 reaches a point between the halfway point of the forward movement and the end of the forward movement. When judged that the driving time is equal to or less than the second predetermined time period (NO at Step S30), the CPU 209 continues to drive the first driving section 13.

Conversely, when judged that the driving time has exceeded the second predetermined time period (YES at Step S30), the CPU 209 controls the second driving section 15 to rotate the sticking section 14 with the first driving section 13 being driven (Step S32). This rotation causes the sticking strength of the sticking section 14 to change when the sticking section 14 is separated from the page P, and then causes a point on the peripheral surface of the sticking section 14 which sticks to the subsequent page P at the next page-turning start point to change.

Then, the CPU 209 judges whether or not the driving time of the first driving section 13 has exceeded the first predetermined time period (Step S34). When judged that the driving time is equal to or less than the first predetermined time period (NO at Step S34), the CPU 209 continues to drive the first driving section 13 and the second driving section 15.

Also, the page P is separated from the sticking section 14 when the second driving section 15 is being rotated (see the block 103 shown in FIG. 3). Here, air from the air blowing section 16 is blown onto the page P separated from the sticking section 14. Accordingly, the page P can be prevented from returning to its page-turning start point after being guided to the page-turning end point. Also, the sticking section 14 is positioned away from the page P at the page-turning end point with it being separated from the page P. At this position, the sticking section 14 and the arm section 12 are not within the viewing angle of the camera in the information processing terminal 300.

The page P separated from the sticking section 14 (or the page P immediately before being separated) is caught by the catching section in the page holding section 30, and guided to the outer peripheral surface of the pull-in roller 32. This page P which has reached the pull-in roller 32 is pulled into the page-turning end point by the pull-in roller 32 and the pressing roller 33.

Here, the movement of the binding portion of the page P on the side opposite to the sticking section 14 is being restricted by the arm 51 of the position control section 50. Accordingly, the distance between an end (on the outside margin side) of the page P and the page holding section 30 is adjusted, and the end (on the outside margin side) of the page P is not deformed in a U shape and not pulled in by the pull-in roller 32 and the pressing roller 33 in the page holding section 30.

On the other hand, when judged that the driving time has exceeded the first predetermined time period (YES at Step S34) the CPU 209 first outputs a press OFF signal to the motor driver 205 for driving the position control section (motor) 50 (Step S35). Thus, the arm 51 of the position control section 50 enters the standing and releasing (substantially vertical) state SB where the movement of the page P is not restricted (see the block 103 shown in FIG. 3).

In a process for the arm 51 to rotate to enter the released (substantially vertical) state SB, the end (on the outside margin side) of the page P is pulled in by the pull-in roller 32 and the pressing roller 33 in the page holding section 30. Finally, the turned page P is completely pulled in by the page holding section 30 and held therein. Here, the arm 51 of the position control section 50 is in the standing and releasing (substantially vertical) state SB where the movement of the page P is not restricted. Thus, the arm 51 is not within the viewing angle of the camera in the information processing terminal 300.

Then, the CPU 209 stops the first driving section 13 and the second driving section 15 (Step S38). Here, the arm section 12 attempts to continue to rotate clockwise with an inertial force. However, a stopper (not shown) provided in the accommodation case 11 restricts its further rotation.

Then, the CPU 209 outputs a page-turning completion signal to the information processing terminal 300 (Step S40). The information processing terminal 300 controls the camera based on the inputted page-turning completion signal, and photographs the page P at the page-turning start point among the currently opened pages P (Step S42).

Here, the sticking section 14, the arm section 12, the air blowing section 16, and the page holding section 30 are away from the viewing angle of the camera, and only the pages P the page-turning end point are photographed. The data of images captured by the camera are numbered one by one (for each image capturing), and recorded in a recording section (a memory or a recording medium) in the information processing terminal 300. In this case where only pages P corresponding to page-turning start points, such as odd-numbered pages, are imaged, images acquired by photographing only the odd-numbered pages and images acquired by photographing only the even-numbered pages by arranging the even-numbered pages at page-turning start points are alternately rearranged in the page order as scan images corresponding to all the pages.

Then, the CPU 209 adds 1 to an N value and stores a value acquired by the addition in the RAM 207 (Step S44). As such, the CPU 209 and the RAM 207 are each a measurement section which measures the number of times of turning. Then, the CPU 209 judges whether or not the N value is equal to a predetermined value (Step S46). The predetermined value is an upper limit value below which the page holding section 30 can stably catch pages P. An optimal value of this predetermined value varies depending on the paper type of the pages P and the size of the book B. In the present embodiment, for example, 50 is used as the predetermined value.

That is, when page turning is performed a certain number of times, the entire thickness of pages P held at page-turning end points increases, whereby a page holding capability by the pace holding section 30 decreases. Accordingly, when the number of turned pages has not reached a predetermined value, the CPU 209 performs control to continue a page-turning operation. When the number of turned pages reaches the predetermined value, the CPU 209 temporarily stops the page-turning operation at that point, and controls to prompt the user to set the page holding section 30 again.

That is, when judged that the N value is not equal to the predetermined value (NO at Step S46), the CPU 209 judges whether or not the user has given an instruction to stop the page-turning operation (Step S56). When judged that no instruction has been given to stop the page-turning operation (NO at Step S56), the processing returns to Step S18. At Step S18, the CPU 209 repeats the above-described page-turning operation and imaging operation.

Conversely, when judged that the N value has reached the predetermined value (YES at Step S46), the CPU 209 continues to stop the first driving section 13 and the second driving section 15 (Step S43). Then, the CPU 209 stops the page holding section 30 (rotation thereby) via the motor driver 204 (Step S50), and resets the N value stored in the RAM 207 to zero (Step S52).

When the page holding section 30 is stopped, the user sets the page holding section 30 again. More specifically, the user fixes a plurality of pages P at page-turning end points to the other holding plate 22 by using a clip (not shown). In addition, the user adjusts the page holding section 30 at an appropriate position, and then gives an instruction to restart the page-turning operation from the information processing terminal 300.

The CPU 209 judges whether or not the user has given an instruction to restart the page-turning operation (Step S54). When judged that the user has not given an instruction to restart the page-turning operation (NO at Step S54), the CPU 209 continues the current state.

Conversely, when judged that the user has given an instruction to restart the page-turning operation (YES at Step S54), the CPU 209 returns to Step S18. At Step S18, the CPU 209 repeats the above-described page-turning operation and imaging operation.

Then, when judged that the user has given an instruction to stop the page-turning operation (YES at Step S56), the CPU 209 ends the page-turning processing. As a result, the imaging of the desired number of pages P is completed.

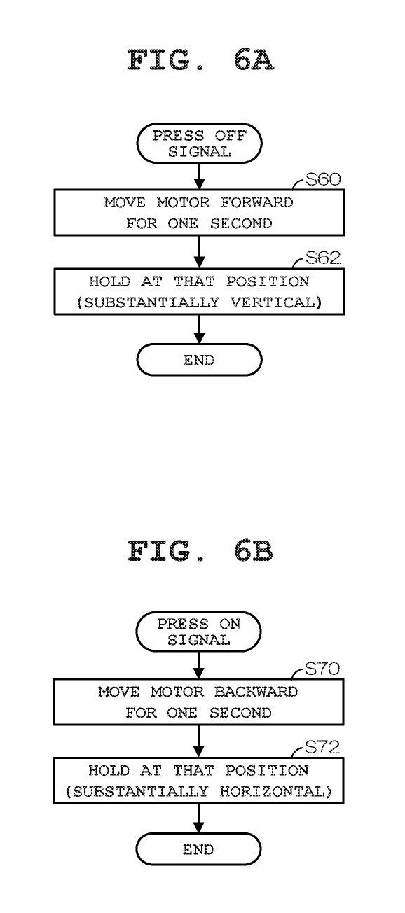

FIGS. 6A and 6B are each a flowchart for describing respective operations of the motor driver 205 for driving the position control section (motor) 50 and the position control section (motor) 50 according to the present embodiment. The motor driver 205 rotates the position control section (motor) 50 forward for one second as shown in FIG. 6A when it receives a press OFF signal from the CPU 209 (Step S60), and holds the arm 51 at that position (substantially vertical) (Step S62). Then, the motor driver 205 ends the processing.

On the other hand, the motor driver 205 rotates the position control section (motor) 50 backward for one second as shown in FIG. 6B when it receives a press ON signal from the CPU 209 (Step S70), and holds the arm 51 at that position (a position where it comes in contact with a page P; substantially horizontal) (Step S72). Then, the motor driver 205 ends the processing.

According to the above-described embodiment, the arm 51 of the position control section 50 restricts the movement of a page P to be turned in synchronization with a page-turning operation. Accordingly, the page P to be turned is pulled in by the pull-in roller 32 and the pressing roller 33 in the page holding section 30 while being inclined. Therefore, the end (on the outside margin side) of the page P can be prevented from curling in a U shape, and a paper jam can be prevented from occurring by the pull-in roller 32 and the pressing roller 33 in the page holding section 30.

Also, according to the above-described embodiment, the arm 51 restricts a page movement caused by a page-turning operation, on one end of a page P located on the side opposite to the other end of the page P stuck to the sticking section 14, whereby the page P to be turned is pulled in by the pull-in roller 32 and the pressing roller 33 in the page holding section 33 while being inclined. As a result of this structure, the end of a page P on the side opposite to the sticking section 14 can be prevented from curling in a U shape, and a paper jam can be prevented from occurring by the pull-in roller 32 and the pressing roller 33 in the page holding section 30.

Moreover, according to the above-described embodiment, the arm 51 restricts a page movement caused by a page-turning operation, on the binding side of one end of a page P which is located on the side opposite to the other end of the page P stuck to the sticking section 14, whereby the page P to be turned is pulled in by the pull-in roller 32 and the pressing roller 33 in the page holding section 30 while being inclined. As a result of this structure, the end of a page P on the side opposite to the sticking section 14 can be prevented from curling in a U shape, and a paper jam can be prevented from occurring by the pull-in roller 32 and the pressing roller 33 in the page holding section 30.

Furthermore, according to the above-described embodiment, the arm 51 presses an upper surface on the binding side of one end of a page P located on the side opposite to the other end of the page P stuck to the sticking section 14, whereby the page P to be turned is pulled in by the pull-in roller 32 and the pressing roller 33 in the page holding section 30 while being inclined. As a result of this structure, the end of a page P on the side opposite to the sticking section 14 can be prevented from curling in a U shape, and a paper jam can be prevented from occurring by the pull-in roller 32 and the pressing roller 33 in the page holding section 30.

Still further, according to the above-described embodiment, the arm 51 of the position control section 50 restricts the movement of a page P to be turned until one end of the page P stuck to the sticking section 14 starts to be caught by the page holding section 30, whereby the page P to be turned is pulled in by the pull-in roller 32 and the pressing roller 33 in the page holding section 30 while being inclined. Accordingly, the end of the page P on the opposite side to the sticking section 14 can be prevented from curling in a U shape, and a paper jam can be prevented from occurring by the pull-in roller 32 and the pressing roller 33 in the page holding section 30.

Note that the present invention is not limited to the above-described embodiment and may be modified as needed. In the above-described embodiment, a case has been exemplarily described in which the position control section 50 includes the arm 51 which reciprocates to be switched between the page pressed (substantially horizontal) state SA where the movement of a page P to be turned is restricted and the standing and releasing (substantially vertical) state SB where the movement of a turned page P is not restricted. However, a structure may be adopted in which the position control section 50 includes a plate-like or columnar member that is movable to a space between a page P to be turned and a page P which has just been turned, and causes the member to be switched between a state where it has been inserted into the space and a state where it has not been inserted into the space according to control by the control section in the page-turning body section 10, whereby the movement of the page P to be turned is restricted. In this structure, the distance between an end of a page P and the page holding section 30 is adjusted, and the end of the page P on the opposite side to the sticking section 14 can be prevented from curling in a U shape.

While the present invention has been described with reference to the preferred embodiments, it is intended that the invention be not limited by any of the details of the description therein but includes all the embodiments which fall within the scope of the appended claims.

What is claimed is:

1. An apparatus for turning pages of an opened hook, comprising
a turning mechanism which holds a page at a page-turning start point and turns over the page;
a page holding section which moves the page turned over by the turning mechanism to a page-turning end point while catching the page by rotating, and holds the page; and
a restriction section which restricts, during a page-turning operation by the turning mechanism, a page movement caused by the page-turning operation.

2. The apparatus according to claim 1, wherein the turning mechanism holds one end of the page at the page-turning start point and turns over the page toward the page-turning end point, and
wherein the restriction section restricts, during the page-turning operation by the turning mechanism, the page movement caused by the page-turning operation, on an other end located on a side opposite to the one end of the page held by the turning mechanism.

3. The apparatus according to claim 2, wherein the restriction section restricts, during the page-turning operation by the turning mechanism, the page movement caused by the page-turning operation, on a binding side of the other end located on the side opposite to the one end of the page held by the turning mechanism.

4. The apparatus according to claim 3, wherein the restriction section restricts, during the page-turning operation by the turning mechanism, the page movement caused by the page-turning operation by downwardly pressing an upper surface on the binding side of the other end located on the side opposite to the one end of the page held by the turning mechanism.

5. The apparatus according to claim 2, wherein the restriction section restricts, during the page-turning operation by the turning mechanism, the page movement caused by the page-turning operation until the one end of the page held by the turning mechanism starts to be caught by the page holding section.

6. The apparatus according to claim 5, wherein the restriction section comprises
an arm having a predetermined length;
a driving section which is connected to the arm such that a rotation axis is perpendicular to the arm, and rotates the arm; and
a control section which, by controlling the arm to be in a substantially horizontal state, (i) controls one end of the arm to be pressed on an upper surface on a binding side of the other end located on the side opposite to the one end of the page held by the turning mechanism during the page-turning operation by the turning mechanism, and (ii) releases restriction of the page movement by controlling the arm to be in a substantially vertical state at timing at which the one end of the page held by the turning mechanism starts to be caught by the page holding section.

7. A method for turning pages of an opened book, comprising:
holding a page at a page-turning start point by a turning mechanism and turning over the page toward a page-turning end point;
restricting, during a page-turning operation by the turning mechanism, a page movement caused by the page-turning operation; and
moving the page at a position in middle of the page-turning operation by the turning mechanism to the page-turning end point while catching the page by a page holding section.

8. The method according to claim 7, wherein the restricting restricts, during the page-turning operation by the turning mechanism, the page movement caused by the page-turning operation by downwardly pressing an upper surface on a binding side of the page held by the turning mechanism.

9. The method according to claim 7, wherein the restricting restricts, during the page-turning operation by the turning mechanism, the page movement caused by the page-turning operation until an end of the page held by the turning mechanism starts to be caught by the page holding section.

10. The method according to claim 7, wherein the restricting restricts, during the page-turning operation by the turning mechanism, the page movement caused by the page-turning operation by pressing an arm on an upper surface on a binding side of the page held by the turning mechanism.

11. The method according to claim 10, further comprising
releasing restriction of the page movement by causing the arm to be in a vertical state at timing at which an end of the page held by the turning mechanism starts to be caught by the page holding section.

12. The method according to claim 7, wherein the restricting restricts, during the page-turning operation by the turning mechanism, the page movement caused by the page-turning operation by maintaining an arm in a horizontal state in an area above a binding side of the page held by the turning mechanism.

13. The method according to claim 12, further comprising:
releasing restriction of the page movement by causing the arm to be in a vertical state at timing at which an end of the page held by the turning mechanism starts to be caught by the page holding section.

14. A method for turning pages of an opened book, comprising:
holding an end of a page at a page-turning start point by a turning mechanism with a predetermined upper surface on a binding side of the page at the page-turning start point being pressed by a control mechanism, and turning over the page toward a page-turning end point; and
releasing press of the control mechanism against the predetermined upper surface at timing at which the page turned over by the turning mechanism starts to be caught by a holding mechanism provided at the page-turning end point.
